(19) United States
(12) Patent Application Publication
(10) Pub. No.: US 2021/0061274 A1
(43) Pub. Date: Mar. 4, 2021

(54) VEHICLE CONTROL SYSTEM WITH PEDAL-BASED SPEED CONTROL

(71) Applicant: Sergio Omar ESCALANTE, Mendoza (AR)

(72) Inventor: Sergio Omar ESCALANTE, Mendoza (AR)

(21) Appl. No.: 16/958,639

(22) PCT Filed: Dec. 27, 2018
(86) PCT No.: PCT/US2018/067723

§ 371 Date: Jun. 26, 2020

Related U.S. Application Data
(60) Provisional application No. 62/643,589, filed on Mar. 15, 2018.
(60) Provisional application No. 62/606,149, filed on Dec. 27, 2017.

(51) Int. Cl. B60W 30/16; B60W 40/105

(52) U.S. Cl. CPC B60W 30/162; B60W 40/105; B60W 2754/10; B60W 2540/12; B60W 2540/10; B60W 2540/14

(57) ABSTRACT

A method for controlling a vehicle having an accelerator pedal and a brake pedal includes monitoring a position of the accelerator pedal. The position of the accelerator pedal varies from a lower limit corresponding to a released state to an upper limit corresponding to a fully depressed state. The method includes monitoring whether the brake pedal is depressed or released and, when depressed, deactivating a setpoint. The method includes, while the brake pedal remains released and in response to determining that the accelerator pedal is depressed: determining a maximum value of the position of the accelerator pedal and, in response to determining that the accelerator pedal has returned to the released state, selectively activating the setpoint and storing a current speed of the vehicle as a setpoint speed. The method includes, while the setpoint is activated, controlling the vehicle to remain at the setpoint speed.

### CROSS-REFERENCE TO RELATED APPLICATIONS

This application claims the benefit of U.S. Provisional Application No. 62/606,149, filed Dec. 27, 2017 and U.S. Provisional Application No. 62/643,589, filed Mar. 15, 2018. The entire disclosures of the applications referenced above are incorporated by reference.

### FIELD

The present disclosure relates to vehicle control systems and more particularly to speed control systems for land vehicles.

### BACKGROUND

Vehicles are often equipped with cruise control systems that help to maintain a constant speed of the vehicle without the need to receive continuous accelerator pedal input from a driver of the vehicle. Traditional cruise control systems are controlled by multiple buttons, which are usually located on or near a steering wheel of the vehicle. The buttons commonly include an on/off button, a set button, a clear button, a reset button, an accelerate button, and a decelerate button. Some of the functions of these buttons may be combined into a single button.

The on/off button enables or disables cruise control. The set and decelerate buttons are used to adjust a desired cruise control speed. The cruise control system maintains the vehicle speed at the desired cruise control speed. When the driver applies the vehicle's brakes, the cruise control system disengages. The driver of the vehicle may reengage cruise control at the prior desired cruise control speed by pressing the resume button. For various reasons, including the complicated multi-button control process, cruise control systems are generally disabled below a threshold speed, such as 25 or 30 miles per hour.

The location of the cruise control buttons may vary from vehicle to vehicle, especially across different manufacturers. For example, one vehicle manufacturer may have the controls on the steering wheel, while another manufacturer has the controls on a control stalk next to the steering wheel. Additionally, the identity and role of buttons varies across vehicle manufacturers. Still further, visual feedback—for whether cruise control is enabled, whether cruise control is active, and the desired cruise control speed—varies widely across manufacturers.

Especially for a driver in an unfamiliar car, such as a rental car, learning the car's cruise control system may distract from driving and will often be avoided by the driver. Further, even with familiar systems, most drivers do not engage cruise control unless they are driving long distances on freeways. Everyday driving therefore does not benefit from traditional cruise control systems.

The background description provided here is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

A method for controlling a vehicle having an accelerator pedal and a brake pedal includes monitoring a position of the accelerator pedal. The position of the accelerator pedal varies from a lower limit corresponding to a released state to an upper limit corresponding to a fully depressed state. The method includes monitoring whether the brake pedal is depressed or released and, when depressed, deactivating a setpoint. The method includes, while the brake pedal remains released and in response to determining that the accelerator pedal is depressed: determining a maximum value of the position of the accelerator pedal and, in response to determining that the accelerator pedal has returned to the released state, selectively activating the setpoint and storing a current speed of the vehicle as a setpoint speed. The method includes, while the setpoint is activated, controlling the vehicle to remain at the setpoint speed.

In other features, controlling the vehicle to remain at the setpoint speed is only performed while the setpoint is activated. In other features, controlling the vehicle to remain at the setpoint speed includes outputting an adjusted accelerator pedal position based on a difference between the setpoint speed and the current speed of the vehicle. In other features, activation of the setpoint is prevented in response to the current speed of the vehicle being below a predetermined activation speed. The predetermined activation speed is zero. In other features, the maximum value is a local maximum value of the position of the accelerator pedal. In other features, the maximum value is a most recent local maximum value of the position of the accelerator pedal.

In other features, the method includes, in response to determining that the accelerator pedal has returned to the released state, selectively determining a rate of release of the accelerator pedal and, in response to the rate of release being less than a threshold, activating the setpoint and storing the current speed of the vehicle as the setpoint speed. In other features, the method includes, in response to the rate of release being greater than the threshold, selectively activating the setpoint and maintaining the setpoint speed without modification. In other features, the method includes initializing the setpoint speed to an initial value following power-on of the vehicle and, in response to the rate of release being greater than the threshold: in response to the setpoint speed being the initial value, activating the setpoint and storing the current speed of the vehicle as the setpoint speed; and, in response to the setpoint speed being different than the initial value, activating the setpoint and maintaining the setpoint speed without modification.

In other features, the maximum value is a most recent local maximum value of the position of the accelerator pedal. Determining the rate of release of the accelerator pedal comprises determining a time at which the accelerator pedal reaches a first position; and calculating the rate of release based on a difference between the time at which the accelerator pedal reached the first position and a time at which the accelerator pedal reached the released state. The first position is a predetermined percentage of the local maximum. In other features, the predetermined percentage is less than or equal to 50 percent. In other features, the method includes deactivating the setpoint in response to determining that the accelerator pedal is not in the released state.

In other features, the vehicle includes a sensor configured to sense an object located along a travel path of the vehicle. The method includes receiving information indicating a distance from the vehicle to the object and deactivating the setpoint in response to determining that the distance is less than a minimum distance. In other features, the method includes determining the minimum distance based on the current speed of the vehicle. In other features, the method includes, in response to the distance crossing the minimum distance in an increasing direction, selectively activating the setpoint and storing the current speed of the vehicle as the setpoint speed.

In other features, the method includes receiving information indicating a relative speed difference between the vehicle and the object; and deactivating the setpoint in response to determining that the relative speed difference is greater than a threshold. In other features, the method includes, in response to the relative speed difference crossing the threshold in a decreasing direction, selectively activating the setpoint and storing the current speed of the vehicle as the setpoint speed. In other features, the vehicle includes a sensor configured to determine a relative speed difference between the vehicle and an object located along a travel path of the vehicle. The method includes receiving information indicating the relative speed difference; and deactivating the setpoint in response to determining that the relative speed difference is greater than a threshold.

In other features, the method includes determining the threshold based on the current speed of the vehicle. In other features, the method includes, in response to the relative speed difference crossing the threshold in a decreasing direction, selectively activating the setpoint and storing the current speed of the vehicle as the setpoint speed. In other features, the method includes receiving information indicating a distance from the vehicle to the object and deactivating the setpoint in response to determining that the distance is less than a minimum distance. In other features, the method includes, in response to the distance crossing the minimum distance in an increasing direction, selectively activating the setpoint and storing the current speed of the vehicle as the setpoint speed.

In other features, the vehicle has a manual transmission and a clutch pedal. The method includes determining whether the clutch pedal is one of depressed and released and deactivating the setpoint in response to determining that the clutch pedal is depressed. In other features, the method includes selectively activating the setpoint and storing the current speed of the vehicle as the setpoint speed in response to concurrent detection of: (i) a transition of the clutch pedal from depressed to released, (ii) the manual transmission being in a forward gear, and (iii) the brake pedal being released. In other features, the method includes selectively activating the setpoint and storing the current speed of the vehicle as the setpoint speed in response to concurrent detection of: (i) a transition of the clutch pedal from depressed to released, (ii) the manual transmission being in a forward gear, (iii) the brake pedal being released, and (iv) the accelerator pedal being in the released state.

In other features, the vehicle has a transmission. The method includes selectively activating the setpoint and storing the current speed of the vehicle as the setpoint speed in response to concurrent detection of: (i) a transition of the brake pedal from depressed to released and (ii) the transmission being in a forward gear. In other features, the vehicle has a transmission. The method includes selectively activating the setpoint and storing the current speed of the vehicle as the setpoint speed in response to concurrent detection of: (i) a transition of the brake pedal from depressed to released, (ii) the transmission being in a forward gear, and (iii) the accelerator pedal being in the released state.

In other features, the vehicle has an automatic transmission. The method includes deactivating the setpoint in response to the automatic transmission being in a non-forward gear. In other features, the method includes selectively activating the setpoint and storing the current speed of the vehicle as the setpoint speed in response to concurrent detection of: (i) the automatic transmission being switched into a forward gear, (ii) the accelerator pedal being released, and (iii) the brake pedal being released.

In other features, the automatic transmission has a manual control mode and an automatic control mode. The method includes deactivating the setpoint in response to the automatic transmission being in the manual control mode. The method further includes selectively activating the setpoint and storing the current speed of the vehicle as the setpoint speed in response to concurrent detection of: (i) the automatic transmission being switched from the manual control mode to the automatic control mode, (ii) the accelerator pedal being released, and (iii) the brake pedal being released.

In other features, the method includes preventing activation of the setpoint in response to driver actuation of a first button. In other features, the first button is a toggle button that alternately selects first and second states. Activation of the setpoint is prevented only in the first state. In other features, activation and deactivation of the setpoint are performed independently of any buttons other than the first button.

In other features, the vehicle includes an automatic transmission and a transmission interface device. Activation and deactivation of the setpoint are performed independently of any driver inputs other than the accelerator pedal, the brake pedal, the transmission interface device, and the first button. In other features, the vehicle includes a manual transmission, a shift lever, and a clutch pedal. Activation and deactivation of the setpoint are performed independently of any driver inputs other than the accelerator pedal, the brake pedal, the clutch pedal, the shift lever, and the first button.

In other features, an apparatus is configured to implement any of the above methods. For example, the apparatus may be an engine control module. In other features, a non-transitory computer-readable medium includes instructions that implement any of the above methods. In other features, the vehicle further includes a steering wheel and the method includes, while the setpoint is activated, monitoring a position of the steering wheel. The method further includes, in response to determining that a rate of change in position of the steering wheel exceeds a predetermined threshold, deactivating the setpoint. In other features, monitoring the position of the steering wheel includes maintaining a moving average of angular velocity of the steering wheel. In other features, the method includes, in response to the current speed of the vehicle exceeding a maximum speed, deactivating the setpoint. In other features, the maximum speed is determined based on a location of the vehicle. For example, the maximum speed may be obtained from a vehicle navigation system based on a speed limit corresponding to the location of the vehicle.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a flowchart depicting overall state control of an example implementation of a constant speed system according to the principles of the present disclosure.

FIG. 2 is a flowchart depicting example vehicle control in response to activation of a setpoint of the constant speed system.

FIG. 3 is a flowchart depicting example operation of setpoint activation for the constant speed system.

FIGS. 4A and 4B are flowcharts depicting example operation of setpoint activation based on accelerator pedal position for the constant speed system.

FIG. 5 is a flowchart depicting example operation of setpoint deactivation for the constant speed system.

FIG. 6 is a functional block diagram depicting an example constant speed system retrofitted to an engine control module.

FIG. 7 is a plot of experimental data demonstrating the fuel savings consistent with an implementation of the present disclosure.

In the drawings, reference numbers may be reused to identify similar and/or identical elements.

### DETAILED DESCRIPTION

A constant speed system described by the present disclosure allows a driver of a vehicle to control a desired speed of the vehicle simply by using existing pedals—specifically, the accelerator pedal, brake pedal, and for vehicles with manual transmissions, the clutch pedal. Using existing pedals represents a significant break with the confusing multiple buttons of traditional cruise control systems. The present disclosure can be implemented with no buttons or with a single button, which simply acts to enable or disable the constant speed system in its entirety.

For example, the single button may act as a toggle, to turn on and off the constant speed system of the present disclosure. While additional buttons are no longer necessary with the disclosed constant speed system, various implementations may integrate the disclosed constant speed system with a traditional button-based cruise control system to cater to those drivers more comfortable with the traditional button-based cruise control system.

By relying on pedal operation, the constant speed system of the present disclosure minimizes driver distraction, as there are not multiple buttons (each associated with text that the driver may need to read) that must be used in concert to control the constant speed system. In fact, a basic implementation of the constant speed system can be formulated as follows: the driver releasing any pedal (while no other pedal is depressed) acts to activate a setpoint, while pressing any pedal deactivates the setpoint; while the setpoint is activated, vehicle speed will be maintained at a setpoint speed; and the setpoint speed is simply the vehicle speed at the time the pedal is released. In fact, there may be no lower bound on vehicle speed at which the constant speed system will operate. In other words, the constant speed system may operate at any vehicle speed greater than zero.

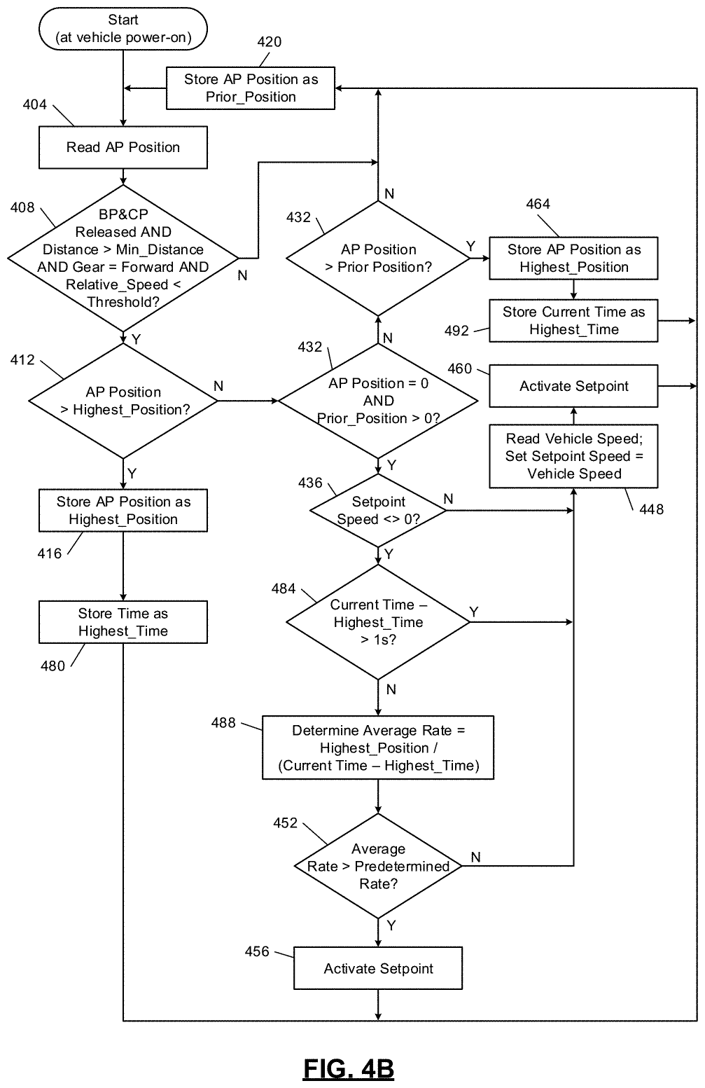

More nuanced determinations of the setpoint speed are described below with respect to FIGS. 4A and 4B. These are examples only, and describe determining the setpoint speed depending on how quickly the accelerator pedal is released. In these implementations, when the accelerator pedal is released slowly, the setpoint speed may be set according to the vehicle speed at the moment the accelerator pedal is fully released. If the accelerator pedal is released rapidly, the setpoint speed may remain at a previously set speed.

At lower speeds and in more complicated driving regimes, such as with different speeds possible due to speed limits and traffic conditions, using traditional cruise control imposes too great an overhead on driver attention. Because of this, drivers avoid the extra effort, which may actually be beneficial given the distraction involved in trying to use traditional cruise control across varied operational regimes.

Meanwhile, the driver effort involved in using a constant speed system according to the principles of the present disclosure is minimal, and has a very gradual learning curve. A driver using the constant speed system of the present disclosure is able to avoid inadvertent speeding above the speed limit as well as inadvertent slowing below the speed limit, both of which may pose hazards to the driver as well as surrounding traffic.

In addition to safety and driver convenience benefits, maintaining a constant vehicle speed allows for substantial fuel consumption benefits. Substantially more energy is required to accelerate to a certain speed than to maintain that speed. Reducing fuel consumption directly causes reductions in greenhouse gas and other emissions.

For standard production vehicles, the driver-controllable inputs to the constant speed system may be strictly limited to a single on/off control (such as a two-position switch or a momentary toggle switch), the accelerator pedal, the brake pedal, the clutch pedal (for a manual transmission), and transmission interface device (such as the shift lever of a manual transmission or the stalk, lever, or knob of an automatic transmission).

In various implementations, actuators other than foot pedals may be used as inputs to the constant speed system. For example, hand-operated controls may be installed for drivers with certain physical limitations.

### Example Control Operation

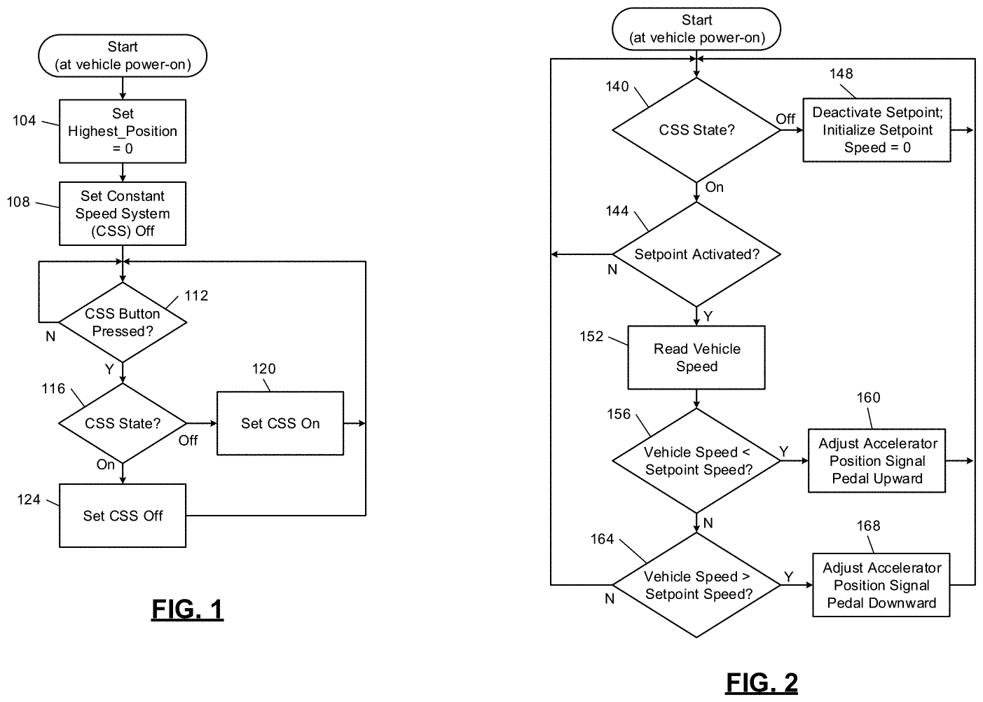

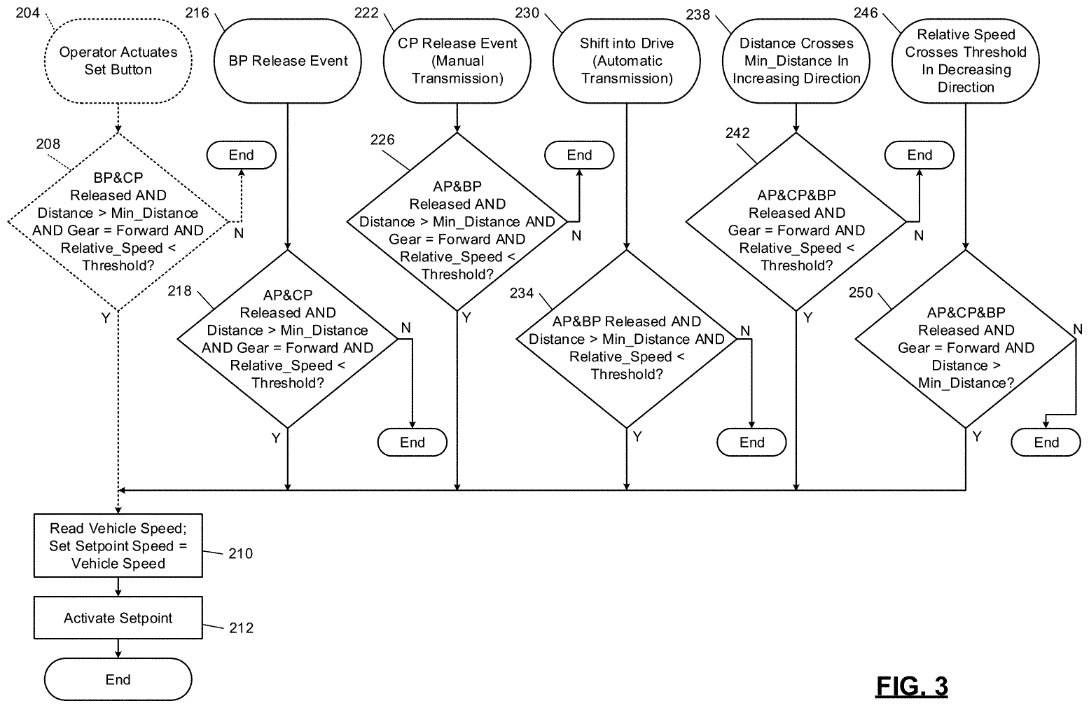

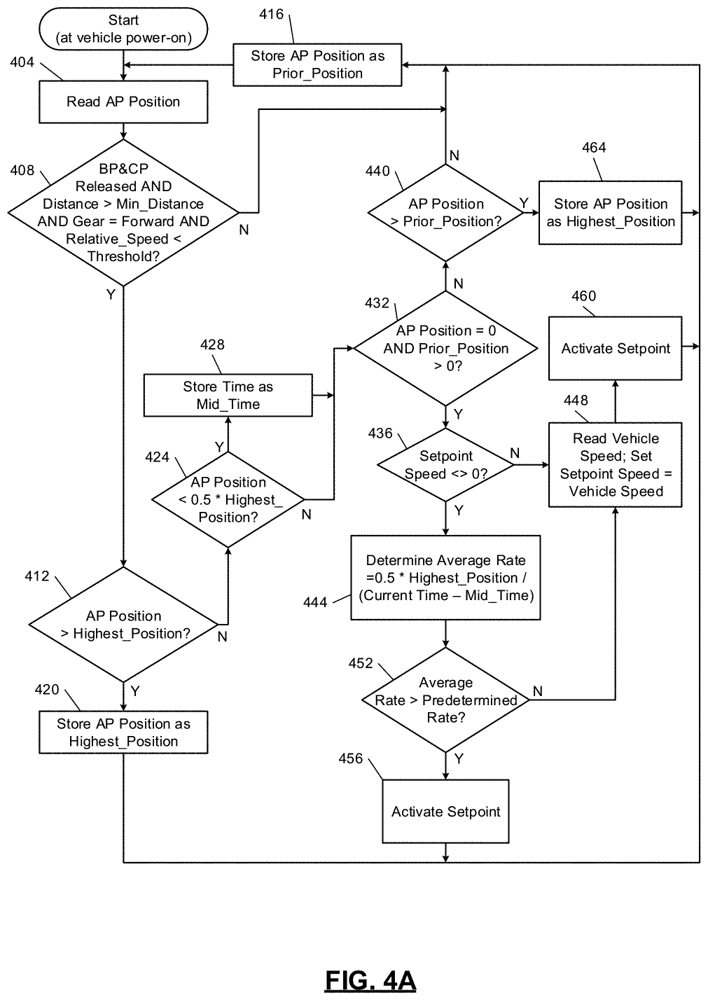

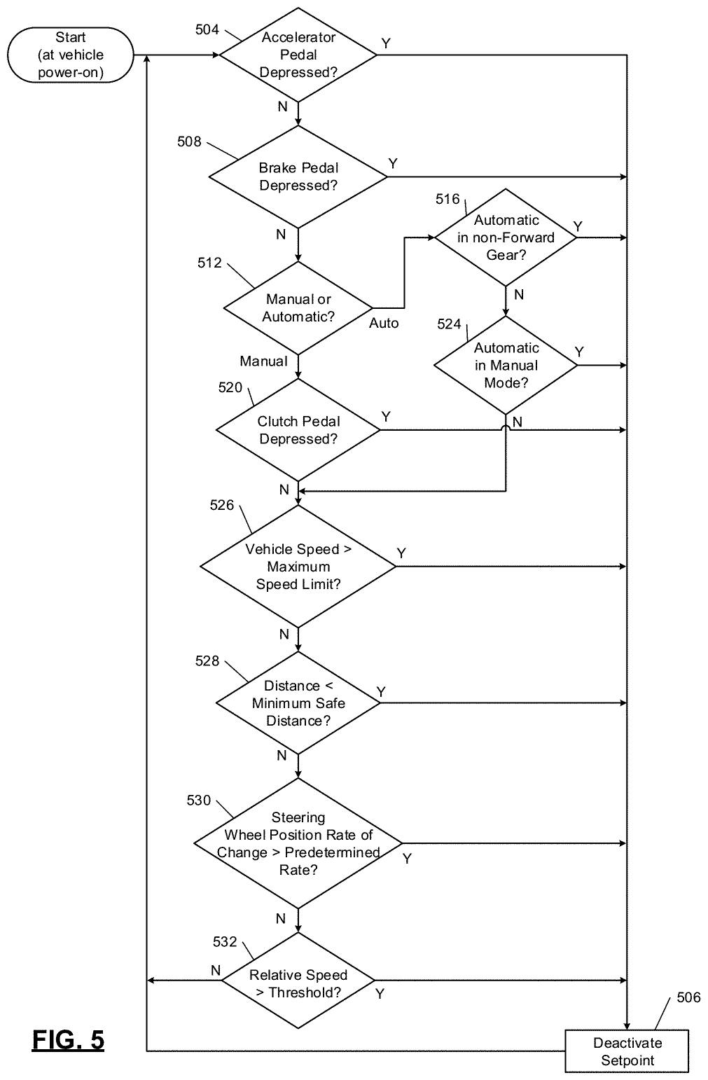

Example operation of a constant speed system (CSS) in a vehicle is described in FIG. 1, FIG. 2, FIG. 3, FIG. 4A, and FIG. 4B. In brief, FIG. 1 operates to control overall enabling of the CSS. FIG. 2 operates to maintain a vehicle speed while a setpoint is activated. FIG. 3 describes activating the setpoint in response to various vehicle operating conditions. FIG. 4A describes activating the setpoint based on accelerator pedal position. FIG. 4B represents an alternative approach to activating the setpoint based on the accelerator pedal position. FIG. 5 describes operation for deactivating the setpoint.

In FIG. 1, control begins upon vehicle power-on at 104. Control initializes a variable named Highest_Position to an initial value such as zero. This variable will be used in FIG. 4A to determine a highest position of an accelerator pedal signal—that is, the furthest that the driver has depressed the accelerator pedal. As used in this description, the term depressed means that the driver is applying enough force to a pedal to move the pedal from its resting location. Meanwhile, the term released means that the driver is not applying enough force to the pedal to move the pedal from its resting location (to which the pedal returns, usually due to a spring force). As a convention in this description, a pedal position of zero corresponds to the pedal being released.

At 108, control initializes the constant speed system (CSS) to the off state. At 112, control determines whether the CSS button has been pressed by the user. If so, control transfers to 116; otherwise, control remains at 112. For example, the CSS button may be a physical button or may be a soft button on a touchscreen, a voice-actuated input, or some other human-machine interface. In FIG. 1, the CSS button is described as a single button that operates as a toggle. The button may be replaced by a pair of on/off buttons or a two-position input, such as a switch. In various implementations, the button may provide visual or tactile feedback that the constant speed system is on. In other implementations, visual, auditory, or tactile feedback may notify the driver of one or more of (i) the constant speed system being on, (ii) the setpoint being activated, (iii) the setpoint being deactivated, etc.

At 116, control queries the current CSS state. If the CSS is currently off, control transfers to 120; otherwise, if the CSS is on, control transfers to 124. At 120, control toggles the CSS on and returns to 112. At 124, control toggles the CSS off and returns to 112.

In FIG. 2, control begins upon vehicle power-on at 140, where control queries the CSS state. If the CSS is on, control transfers to 144; otherwise, control transfers to 148. At 148, in response to the CSS being off, control deactivates the setpoint and initializes the setpoint speed to zero. Control then returns to 140. At 144, control determines whether the setpoint is currently activated. If so, control transfers to 152; otherwise, control returns to 140.

At 152, control reads a current vehicle speed. For example, this may be received from a vehicle speed system, which may use wheel speed and transmission gearing to determine current vehicle speed. At 156, control determines whether the vehicle speed is less than the setpoint speed. If so, control transfers to 160; otherwise, control transfers to 164. At 160, control adjusts an accelerator pedal position signal upward (that is, simulating the driver pressing the accelerator pedal further) to increase vehicle speed. Control then returns to 140.

At 164, control determines whether the current vehicle speed is greater than the setpoint speed. If so, control transfers to 168; otherwise, control returns to 140. At 168, control adjusts the accelerator pedal position signal downward (that is, simulating the driver reducing pressure on the accelerator pedal) to decrease vehicle speed. Control then returns to 140. In various implementations, the present disclosure may be used with more complex closed-loop architectures, such as proportional-integral-derivative feedback rather than the simple integral-style control shown in FIG. 2.

In other implementations, such as when the constant speed system is integrated into the vehicle's engine control module, the constant speed system may simply provide the setpoint speed to a speed management module of the engine control module. The speed management module operates, subject to other inputs (such as traction control or engine rev limiter), to maintain the provided speed.

FIG. 3 depicts a series of example events that may result in activating the setpoint. While six events are shown, some or all may be omitted in various implementations of the CSS system. As a first example, the CSS system may include an explicit set button to activate the setpoint for consistency with traditional cruise control systems. In response to an event (204) where the driver actuates the set button, control begins at 208. At 208, control determines whether the brake pedal and (if the vehicle has a manual transmission) the clutch pedal are both released, such as by receiving input from pedal position sensors.

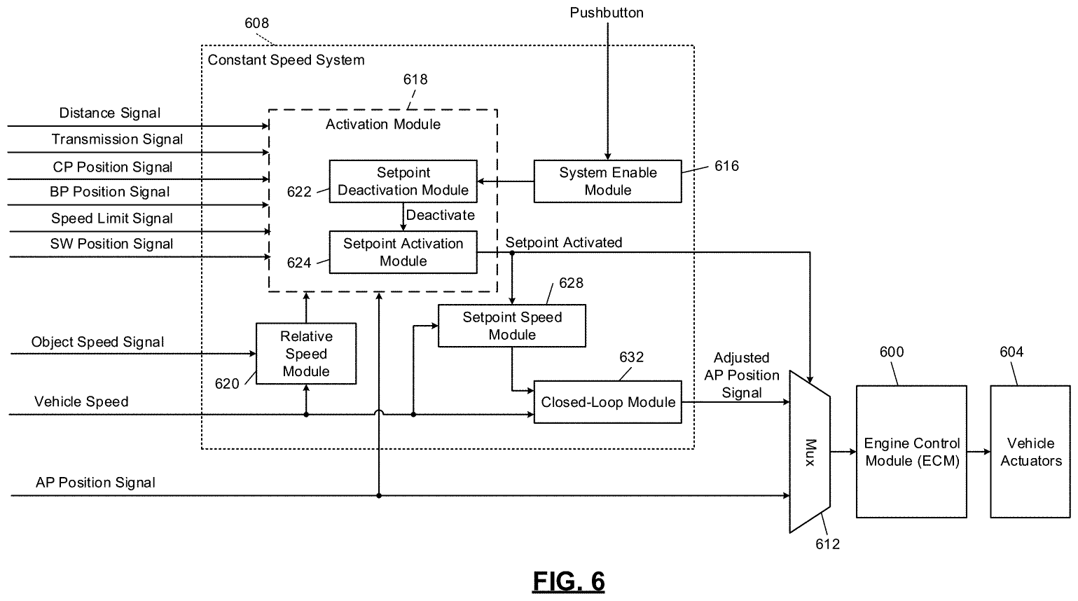

In addition, control determines whether a distance to a closest object in front of the vehicle is greater than a predetermined minimum distance. This distance information may be obtained from sensors such as one or more of laser, Lidar, camera, ultrasonic, and radar. The predetermined minimum distance may be based on current vehicle speed and may be encoded as a lookup table or an equation (such as a polynomial) with speed as an independent variable. In addition, control determines whether a relative speed between the vehicle and the closest object in front of the vehicle is less than a threshold speed. For example, relative speed may be determined directly from a sensor reading related to the object in front of the vehicle, such as by using the Doppler effect. In other implementations, and as depicted in FIG. 6, the relative speed may be calculated as the absolute value of the difference between the vehicle speed and an estimated speed of the closest object in front of the vehicle.

In addition, control determines whether the presently selected gear of the transmission is a forward gear (as opposed to a neutral or reverse gear). If, at 208, all of these conditions are true, control transfers to 210. Otherwise, the conditions for activating the setpoint are not present and control ends. At 210, control reads current vehicle speed and sets the vehicle speed as the setpoint speed. At 212, control activates the setpoint and then the control of FIG. 3 ends until another event shown in FIG. 3 occurs. By setting the setpoint at 212, the control of FIG. 2 will operate to maintain vehicle speed at that setpoint.

If a brake pedal release event (216) occurs, control begins at 218. At 218, control determines whether the accelerator pedal and (if present) the clutch pedal are both released, whether the distance is greater than the minimum distance, whether the presently selected gear is a forward gear, and whether the relative speed is less than the threshold. If all of these conditions are true, control transfers to 210; otherwise, control ends.

In a vehicle with a manual transmission, a clutch pedal release event (222) causes control to begin at 226. If, at 226, both the accelerator pedal and the brake pedal are released, the distance is greater than the minimum distance, the gear selected is a forward gear, and the relative speed is less than the threshold, control transfers to 210; otherwise, control ends.

In an automatic transmission with a manumatic mode (where a user can manually select gears, such as by using buttons, shift lever movement, or shifter paddles), a shift event 230 from the manumatic mode to standard drive mode causes control to begin at 234. The shift event 230 may also encompass a shift from a non-forward gear (such as reverse or neutral) to a forward gear (such as drive) in any type of automatic transmission. At 234, if the accelerator pedal and brake pedal are both released, the distance is greater than the minimum distance, and the relative speed is less than the threshold, control transfers to 210; otherwise, control ends.

A distance event (238) occurs when the distance to the closest object in front of the vehicle is increasing and crosses the minimum distance, which causes control to begin at 242. At 242, if the accelerator pedal, brake pedal, and clutch pedal (if present) are released, the selected gear is a forward gear, and the relative speed is less than the threshold, control transfers to 210; otherwise, control ends.

A relative speed event (246) occurs when the relative speed is decreasing and crosses the threshold, which causes control to begin at 250. If, at 250, the accelerator pedal, brake pedal, and clutch pedal (if present) are all released, the selected gear is a forward gear, and the distance is greater than a threshold, control transfers to 210; otherwise, control ends.

While distance, relative speed, and transmission gear are described as conditions in the above control, some or all of these conditions may be omitted in various implementations with respect to some or all of the described events. In addition, accelerator pedal release may be added as a condition, such as to 208. Further, accelerator pedal release may be removed as a condition, such as from 234, 242, and 250.

Other events for activating the setpoint may be based on accelerator pedal position. For example, FIG. 4A describes setpoint activation based on accelerator pedal position. Control begins upon vehicle power-on at 404, where the position of the accelerator pedal is read. At 408, control determines whether the brake pedal and clutch pedal (if present) are both released, whether the distance to an object in front of the vehicle is greater than the minimum distance, whether the selected gear is a forward gear, and whether the relative speed between the vehicle and an object in front of the vehicle is less than a threshold. If all these conditions are true, control continues at 412; otherwise, control transfers to 416. At 416, control stores the AP position into a variable named Prior_Position and returns to 404.

At 412, control determines whether the AP position is greater than the Highest_Position variable. If so, control transfers to 420; otherwise, control transfers to 424. At 420, control stores the AP position into the Highest_Position variable and transfers to 416. At 424, control determines whether the AP position is less than a predetermined percentage of the Highest_Position variable. If so, control transfers to 428; otherwise, control transfers to 432. The predetermined percentage may be, for example, 50%. The predetermined percentage may be determined empirically based on driver feedback and studies of driver behavior. At 428, control stores the present time (at which the accelerator pedal has moved to a fraction of its greatest excursion) as a variable named Mid_Time.

At 432, control determines whether the accelerator pedal position is currently zero and whether Prior_Position was greater than zero—in other words, whether the accelerator pedal has just been released. If so, control transfers to 436; otherwise, control transfers to 440.

At 436, control determines whether there is a setpoint speed already set (for example, the setpoint speed is not still set to the initial value of zero). If so, control transfers to 444; otherwise, control transfers to 448. At 444, control determines an average rate of pedal release based on how quickly the driver released the pedal through its last fraction of travel. The fraction is the same as defined in 424 (according to the example value shown in FIG. 4A, 50%, or 0.5). In other words, even though the driver may have slowly released the accelerator pedal at first, if the last portion of accelerator pedal travel was rapid, this may indicate the driver's intent to rapidly release the pedal. In the example implementations of FIGS. 4A and 4B, a rapid accelerator pedal release is used to indicate that the driver does not want to set a new setpoint speed and instead retain the prior setpoint speed.

The average rate may simply be calculated as the distance the pedal moved divided by the time between when the pedal was at the fractional position and the current time. In other words, the average rate may be calculated as the predetermined fraction (such as 0.5) times the Highest_Position variable divided by the difference between the current time and the Mid_Time variable.

At 452, control determines whether the average rate is greater than a predetermined rate. If so, this rapid release of the pedal causes control to transfer to 456; otherwise, control transfers to 448. At 456, control activates the setpoint without adjusting the setpoint speed (thereby relying on the previously-set setpoint speed) and returns to 416. At 448, control reads vehicle speed and sets the setpoint speed to the vehicle speed. Control continues at 460, where the setpoint is activated. Control then returns to 416.

At 440, control determines whether the accelerator pedal position is greater than Prior_Position. If so, control transfers to 464; otherwise, control returns to 416. At 464, the increasing pedal position means that a new local maximum will occur and so control resets the Highest_Position to the current accelerator pedal position. Therefore, the Highest_Position variable will track the accelerator pedal position until the accelerator pedal position begins decreasing. In other words, the Highest_Position variable will store the most recent local maximum of accelerator pedal position. Control then returns to 416.

In FIG. 4B, a variant of FIG. 4A is shown. Elements that operate similarly to FIG. 4A will be labeled with the same reference numeral for the sake of illustration. For brevity, the description for operations in FIG. 4B that are similar to those of FIG. 4A can be found above with respect to FIG. 4A.

In FIG. 4B, following 416, control continues at 480, where the time at which the Highest_Position is achieved is stored as a variable Highest_Time. If, at 436, a prior setpoint was set, control transfers to 484. At 484, control determines whether the difference between the current time and the Highest_Time is more than a predetermined threshold, such as one second. If so, the large length of time over which pedal release occurred may make release rate determination unreliable, so control transfers to 448; otherwise, control transfers to 488.

At 488, control determines an average rate based on the Highest_Position variable divided by the difference between the current time and the Highest_Time variable. Control then continues at 452. After 464, control transfers to 492, where the current time is stored into Highest_Time.

In FIG. 5, operation for deactivating the setpoint is described. Control begins upon vehicle power-on at 504. If the accelerator pedal is depressed, control transfers to 506; otherwise, control transfers to 508. At 506, control deactivates the setpoint and returns to 504.

At 508, control determines whether the brake pedal is depressed. If so, control transfers to 506; otherwise, control transfers to 512. At 512, control transfers to 516 if the transmission of the vehicle is an automatic transmission; otherwise, the transmission of the vehicle is a manual transmission, and control transfers to 520. In various implementations, control may be modified in some implementations to work only with automatic transmissions, in which case elements 512 and 520 may be removed. Similarly, a manual-only implementation may omit elements 512, 516, and 524.

At 516, control determines whether the automatic transmission is in a non-forward gear, such as neutral or reverse. If so, control transfers to 506; otherwise, control transfers to 524. At 524, if the automatic transmission is in the manual (or, manumatic) mode, control transfers to 506; otherwise, control transfers to 526. In other implementations, control may transfer from 524 to 506 only in response to the transition from an automatic mode to a manual mode—in other words, the setpoint is deactivated only at the time of transition, and is not forced to remain deactivated. At 520, if the clutch pedal is depressed, control transfers to 506; otherwise, control transfers to 526.

At 526, control determines whether the speed of the vehicle is greater than a maximum speed limit. If so, control transfer to 506; otherwise, control transfer to 528. At 528, control determines whether the distance between the vehicle and the closest object in front of the vehicle is less than a minimum safe distance. If so, control transfers to 506; otherwise, control transfers to 530. As described above, the minimum safe distance may depend on vehicle speed.

At 530, control determines a rate of change in position of the steering wheel. If the rate of change in position of the steering wheel is greater than a predetermined rate, control transfer to 506; otherwise, control transfer to 532. At 532, control determines whether the relative speed between the vehicle and the object in front of the vehicle is greater than a threshold. If so, control transfers to 506; otherwise, control returns to 504. In various implementations, additional or alternative conditions may lead to deactivating the setpoint at 506. For example, if the speed of the engine is limited for some reason, such as by an engine rev limiter (engine RPM redline protection) or traction control system, the setpoint may be deactivated.

### Block Diagram

In FIG. 6, an example vehicle control system is shown. An engine control module 600 operates based on an accelerator pedal position signal (also known as a throttle position sensor input) and controls vehicle actuators 604, such as a throttle valve, fuel injectors, and spark timing. The engine control module 600 may be programmed to attempt to effectuate the driver's desired speed and acceleration, as indicated by the accelerator pedal position.

A constant speed system 608 may be retrofitted to the engine control module 600 by, in one simple example, generating a modified accelerator pedal position signal. A multiplexer 612 is incorporated to select between the modified accelerator pedal position signal and the original accelerator pedal position signal for output to the engine control module 600. Specifically, under control of the constant speed system 608, the multiplexer 612 selects either the original accelerator pedal position signal or the modified accelerator pedal position signal generated by the constant speed system 608.

An activation module 618 may rely on a distance signal indicating a distance between the vehicle and the closest object in front of the vehicle. However, in implementations where the distance signal is not available, control elements related to the distance signal may be omitted without departing from the scope of the present disclosure.

The activation module 618 may also rely on a relative speed between the closest object in front of the vehicle with respect to the speed of the vehicle. As one example, a relative speed module 620 may determine a difference between a current speed of the vehicle and a current speed of the object. When the current speed of the vehicle is greater than a current speed of the object by more than a threshold, the activation module 618 may deactivate the setpoint. The threshold may be based on vehicle speed: for example, the threshold may be determined by a linear equation with vehicle speed as an independent variable. In implementations where the relative or absolute speed of objects in front of the vehicle are not available, control elements related to the relative speed signal may be omitted without departing from the scope of the present disclosure.

The constant speed system 608 includes a system enable module 616 that alternately enables and disables the constant speed system 608 in response to a pushbutton signal under the control of the driver. The activation module 618 includes a setpoint deactivation module 622 that operates to deactivate the setpoint by commanding a setpoint activation module 624 to deactivate the setpoint. In response to the system enable module 616 disabling the constant speed system 608, the setpoint deactivation module 622 will deactivate the setpoint.

When not being deactivated by the setpoint deactivation module 622, the setpoint activation module 624 activates the setpoint, such as according to the conditions shown in FIG. 3 and FIGS. 4A-4B. When the setpoint activation module 624 activates the setpoint, a setpoint speed module 628 selectively latches the current vehicle speed. In certain circumstances, such as are described in FIGS. 4A-4B, certain driver inputs (such as a rapid pedal release) may cause the setpoint speed module 628 to maintain the previously-latched setpoint speed.

The activation module 618 may also rely on one or more of brake pedal (BP) position, clutch pedal (CP) position, accelerator pedal (AP) position, vehicle speed, a maximum speed limit, steering wheel (SW) position, and selected transmission gear. In various implementations, some or all of these signals may be received from the engine control module 600.

The setpoint deactivation module 622 may deactivate the setpoint, based on the speed limit signal, in response to determining that the speed of the vehicle exceeds a maximum speed. The maximum speed may be set by the driver of the vehicle—in some implementations, the driver is not permitted to set the maximum speed above a hardcoded value. In various implementations, the maximum speed is set according to location. For example, a navigation system of the vehicle may provide a new maximum speed to the constant speed system each time the navigation system determines that the applicable speed limit has changed. The navigation system may provide the applicable speed limit as the maximum speed or may apply a positive or negative offset (for example, +5 kph) to the applicable speed limit to create the maximum speed.

The setpoint deactivation module 622 may also deactivate the setpoint, based on the SW position signal, in response to determining that the rate of change in position of the steering wheel exceeds a predetermined threshold. To prevent unintended deactivation by small sharp movements of the steering wheel, such as may be caused by a pothole, an accumulated value may be calculated. For example, an exponentially weighted moving average of the steering wheel angular velocity may be compared to the predetermined threshold. In addition, other conditions (such as are described in FIG. 5) may cause the setpoint deactivation module 622 to deactivate the setpoint.

When the setpoint is activated by the setpoint activation module 624, the multiplexer 612 outputs an adjusted accelerator pedal position signal from the constant speed system 608 to the engine control module 600. A closed-loop module 632 generates the adjusted accelerator pedal position signal for output to the multiplexer 612 in order to minimize a difference between the desired speed and the actual vehicle speed. When the setpoint is deactivated, the closed-loop module 632 may be disabled to avoid building up a difference between the desired speed and the current vehicle speed while the closed-loop module 632 is unable to minimize that difference.

### Experimental Data

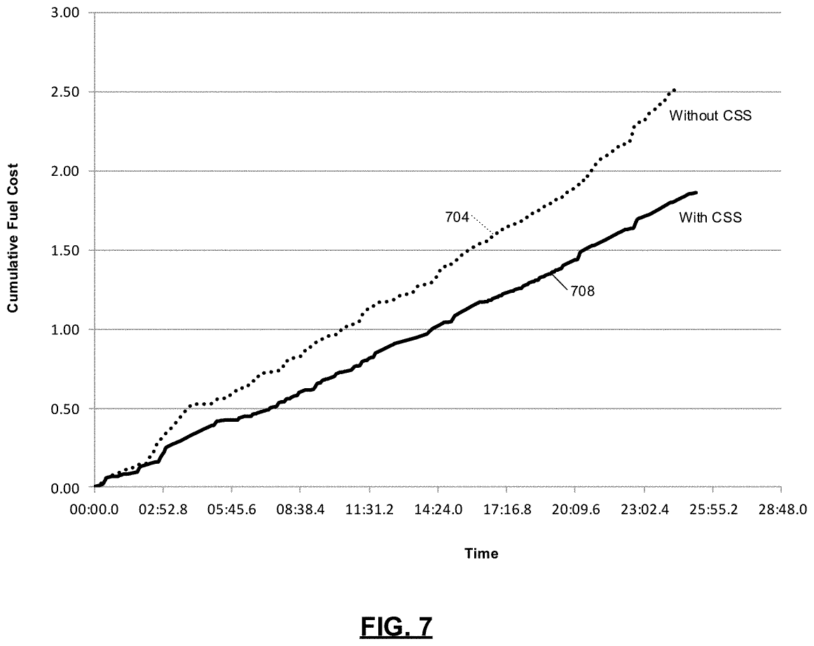

In FIG. 7, experimental data is shown with and without the constant speed system of the present disclosure. Driving time along a predetermined route is plotted on the x-axis, while fuel cost (directly proportional to fuel consumption as well as to emissions, such as carbon dioxide) is plotted on the y-axis. A first trace 704 is shown without the constant speed system—that is, the vehicle was driven along a predetermined route by a driver without using any form of cruise control. Multiple laps of the predetermined route were used to reduce measurement error, and the predetermined route was navigated at night to minimize the impact of traffic variability.

A second trace 708 is shown where a constant speed was maintained during each portion of the route to simulate the constant speed system of the present disclosure. Again, multiple laps of the predetermined route were driven to reduce measurement error. As seen in FIG. 7, the fuel savings are substantial for the second trace 708 (using a constant speed system) compared to the first trace 704 (relying on the driver's intuition). Because the constant speed system of the present disclosure is far easier for drivers to invoke in various operating regimes and at various speeds, the fuel efficiency results shown in FIG. 7 are likely to be replicable for drivers in real-world driving conditions. Meanwhile, potential fuel savings from traditional cruise control systems are much less likely to be realized due to the learning curve and substantial mental load required to control such systems.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

As used herein, the phrase at least one of A, B, and C should be construed to mean a logical (A OR B OR C), using a non-exclusive logical OR, and should not be construed to mean “at least one of A, at least one of B, and at least one of C.” The term subset does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTMLS (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A method for controlling a vehicle having an accelerator pedal and a brake pedal, the method comprising:
monitoring a position of the accelerator pedal, wherein the position of the accelerator pedal varies from a lower limit corresponding to a released state to an upper limit corresponding to a fully depressed state;
monitoring whether the brake pedal is one of depressed and released;
in response to determining that the brake pedal is depressed, deactivating a setpoint;
while the brake pedal remains released, in response to determining that the accelerator pedal is depressed:
determining a maximum value of the position of the accelerator pedal; and
in response to determining that the accelerator pedal has returned to the released state, selectively activating the setpoint and storing a current speed of the vehicle as a setpoint speed; and
while the setpoint is activated, controlling the vehicle to remain at the setpoint speed.

2. (canceled)

3. The method of claim 1 wherein controlling the vehicle to remain at the setpoint speed includes outputting an adjusted accelerator pedal position based on a difference between the setpoint speed and the current speed of the vehicle.

4. (canceled)

5. The method of claim 1 wherein the maximum value is a most recent local maximum value of the position of the accelerator pedal.

6. (canceled)

7. The method of claim 1 further comprising, in response to determining that the accelerator pedal has returned to the released state:
selectively determining a rate of release of the accelerator pedal; and
in response to the rate of release being less than a threshold, activating the setpoint and storing the current speed of the vehicle as the setpoint speed.

8. The method of claim 7 further comprising:
in response to the rate of release being greater than the threshold, selectively activating the setpoint and maintaining the setpoint speed without modification;
initializing the setpoint speed to an initial value following power-on of the vehicle; and
in response to the rate of release being greater than the threshold:
in response to the setpoint speed being the initial value, activating the setpoint and storing the current speed of the vehicle as the setpoint speed; and
in response to the setpoint speed being different than the initial value, activating the setpoint and maintaining the setpoint speed without modification.

9. (canceled)

10. The method of claim 7 wherein
the maximum value is a most recent local maximum value of the position of the accelerator pedal; and
determining the rate of release of the accelerator pedal comprises:
determining a time at which the accelerator pedal reaches a first position, wherein the first position is a predetermined percentage of the maximum value; and
calculating the rate of release based on a difference between the time at which the accelerator pedal reached the first position and a time at which the accelerator pedal reached the released state.

11. (canceled)

12. The method of claim 1 further comprising:
deactivating the setpoint in response to determining that the accelerator pedal is not in the released state,
wherein controlling the vehicle to remain at the setpoint speed is only performed while the setpoint is activated.

13. The method of claim 1 wherein:
the vehicle includes a sensor configured to sense an object located along a travel path of the vehicle; and
the method further comprises:
receiving information indicating a distance from the vehicle to the object;
deactivating the setpoint in response to determining that the distance is less than a minimum distance;
determining the minimum distance based on the current speed of the vehicle;
in response to the distance crossing the minimum distance in an increasing direction, selectively activating the setpoint and storing the current speed of the vehicle as the setpoint speed;
receiving information indicating a relative speed difference between the vehicle and the object;
deactivating the setpoint in response to determining that the relative speed difference is greater than a threshold; and
in response to the relative speed difference crossing the threshold in a decreasing direction, selectively activating the setpoint and storing the current speed of the vehicle as the setpoint speed.

14-17. (canceled)

18. The method of claim 1 wherein:
the vehicle includes a sensor configured to determine a relative speed difference between the vehicle and an object located along a travel path of the vehicle; and
the method further comprises:
receiving information indicating the relative speed difference;
deactivating the setpoint in response to determining that the relative speed difference is greater than a threshold; and
determining the threshold based on the current speed of the vehicle.

19. (canceled)

20. The method of claim 18 further comprising:
in response to the relative speed difference crossing the threshold in a decreasing direction, selectively activating the setpoint and storing the current speed of the vehicle as the setpoint speed;
receiving information indicating a distance from the vehicle to the object;
deactivating the setpoint in response to determining that the distance is less than a minimum distance; and
in response to the distance crossing the minimum distance in an increasing direction, selectively activating the setpoint and storing the current speed of the vehicle as the setpoint speed.

21-22. (canceled)

23. The method of claim 1 wherein:
the vehicle has a manual transmission and a clutch pedal; and
the method further comprises:
determining whether the clutch pedal is one of depressed and released;
deactivating the setpoint in response to determining that the clutch pedal is depressed; and
selectively activating the setpoint and storing the current speed of the vehicle as the setpoint speed in response to concurrent detection of: (i) a transition of the clutch pedal from depressed to released, (ii) the manual transmission being in a forward gear, (iii) the brake pedal being released, and (iv) the accelerator pedal being in the released state.

24-26. (canceled)

27. The method of claim 1 wherein:
the vehicle has a transmission; and
the method further comprises selectively activating the setpoint and storing the current speed of the vehicle as the setpoint speed in response to concurrent detection of: (i) a transition of the brake pedal from depressed to released, (ii) the transmission being in a forward gear, and (iii) the accelerator pedal being in the released state.

28. The method of claim 1 wherein:
the vehicle has an automatic transmission; and
the method further comprises deactivating the setpoint in response to the automatic transmission being in a non-forward gear.

29. The method of claim 28 further comprising selectively activating the setpoint and storing the current speed of the vehicle as the setpoint speed in response to concurrent detection of: (i) the automatic transmission being switched into a forward gear, (ii) the accelerator pedal being released, and (iii) the brake pedal being released.

30. The method of claim 28 wherein:
the automatic transmission has a manual control mode and an automatic control mode;
the method further comprises deactivating the setpoint in response to the automatic transmission being in the manual control mode; and
the method further comprises selectively activating the setpoint and storing the current speed of the vehicle as the setpoint speed in response to concurrent detection of: (i) the automatic transmission being switched from the manual control mode to the automatic control mode, (ii) the accelerator pedal being released, and (iii) the brake pedal being released.

31. (canceled)

32. The method of claim 1 further comprising:
preventing activation of the setpoint in response to driver actuation of a first button,
wherein the first button is a toggle button that alternately selects first and second states,
wherein activation of the setpoint is prevented only in the first state, and
wherein activation and deactivation of the setpoint are performed independently of any buttons other than the first button.

33-34. (canceled)

35. The method of claim 32 wherein:
the vehicle includes an automatic transmission and a transmission interface device; and
activation and deactivation of the setpoint are performed independently of any driver inputs other than the accelerator pedal, the brake pedal, the transmission interface device, and the first button.

36. The method of claim 32 wherein:
the vehicle includes a manual transmission, a shift lever, and a clutch pedal; and
activation and deactivation of the setpoint are performed independently of any driver inputs other than the accelerator pedal, the brake pedal, the clutch pedal, the shift lever, and the first button.

37-39. (canceled)

40. The method of claim 1 wherein:
the vehicle further includes a steering wheel;
the method further comprises:
while the setpoint is activated, monitoring a position of the steering wheel; and
in response to determining that a rate of change in position of the steering wheel exceeds a predetermined threshold, deactivating the setpoint; and
monitoring the position of the steering wheel includes maintaining a moving average of angular velocity of the steering wheel.

41. (canceled)

42. The method of claim 1 further comprising:
in response to the current speed of the vehicle exceeding a maximum speed, deactivating the setpoint,
wherein the maximum speed is determined based on a location of the vehicle, and
wherein:
activation of the setpoint is prevented in response to the current speed of the vehicle being below a predetermined activation speed; and
the predetermined activation speed is zero.

43. (canceled)
